(19) United States
(12) Patent Application Publication
(10) Pub. No.: US 2008/0065828 A1
(43) Pub. Date: Mar. 13, 2008

(54) Method for storing data in electronic computer system and electronic computer system

(76) Inventor: Shigeki Iwamoto, Fukuoka-city (JP)

Correspondence Address: JORDAN AND HAMBURG LLP, 122 EAST 42ND STREET, SUITE 4000, NEW YORK, NY, 10168, US

(21) Appl. No.: 11/519,102

(22) Filed: Sep. 11, 2006

(51) Int. Cl. G06F 12/00

(52) U.S. Cl. 711/114

(57) ABSTRACT

Themes

To provide a server capable of storing data stably and of restoring a normal state in an extremely short time even when there may be trouble.

Solution Means

There is provided an HDD-A 2 connected directly to a motherboard 5 and HDD-B 3 and HDD-C 4 constituting a RAID-1 structure via a RAID board, where fixed data stored in the HDD-A is backed up to the system backup region of the HDD-B using a general-purpose backup tool at a predetermined timing.

### SPECIFICATION

1. Technical Field

The present invention relates to a method for storing data in an electronic computer system and an electronic computer system. In detail, the present invention relates to a method for storing data in an electronic computer system and an electronic computer system capable of restoring to a normal state in an extremely short time, even when there may be trouble, by backing up fixed data at a predetermined timing and replicating variable data in real time.

2. Background Art

In computer networks, servers for providing their functions and data to client computers are key components of networks, and server OSs (Operating Systems) and server application software are adapted for overall management of entire networks. Also, data and information stored in servers are critically important assets when operating networks and performing business processing.

In order to protect such critically important assets included in servers, there has generally been employed a server specific structure called a RAID structure in which a plurality of hard disk drives (hereinafter referred to as HDDS) are managed collectively as one hard disk drive in a server (refer to Non-Patent Document 1, for example).

RAID-1 and RAID-5 structures will hereinafter be described as representatives of RAID structures.

As shown in FIG. 3A, for example, the RAID-1 structure employs a system adapted to write completely the same data into first and second HDDs 102 and 103 that are connected via a RAID board 101 at the same time, each HDD having an OS, application software, and/or data, etc., mixed and recorded therein, where some type of data in one HDD (e.g. first HDD) is recorded, changed, or deleted, while data in the other HDD (e.g. second HDD) is also recorded, changed, or deleted. In the RAID-1 structure, even if one HDD may be damaged, data can be read out from the other HDD, which allows for continuous operation as a system without problems.

Also, as shown in FIG. 3B, for example, the RAID-5 structure employs a system adapted to generate a high-capacity virtual drive 105 by connecting first, second, and third HDDs 102, 103, and 104 via a RAID board 101 and to write the same content of OS, application software, and/or data, etc., if recorded, into a plurality of HDDs such as the first and second HDDS, first and third HDDS, or second and third HDDS, where when any HDD (e.g. second HDD) may crash (e.g. damaged to be unreadable and unwritable) to be changed, the other HDDs (e.g. first and third HDDs) restore the lost data automatically.

Non-Patent Document 1: “e-Words,” an online dictionary of IT terms, searched on Mar. 4, 2004 at the Internet URL: http://e-words.jp/p/c-storage-magnetic-hd-raid.html

### DISCLOSURE OF THE INVENTION

### Problems to be Solved by the Invention

However, since the above-described RAID structures have been devised on the assumption that crashing HDDs are replaced with normal ones, but on the assumption that data stored in the HDDs is backed up (for example, the RAID-1 structure is adapted to write completely the same data into two HDDs at the same time, which causes a state where if one HDD system has a virus, the other HDD system also has the virus simultaneously. That is, a normal state of one HDD cannot be stored in the other HDD. Also, the RAID-5 structure is adapted to write data in a distributed manner, but to back up data), backing up of data is performed using an external medium such as a tape or a backup dedicated server.

In addition, even if the RAID-1 and RAID-5 structures may be employed, average servers have their systems and data mixed therein, being in an extremely unstable system environment.

The present invention has been made in consideration of the above-described problems, and an object thereof is to provide a method for storing data in an electronic computer system and an electronic computer system capable of storing data stably and of restoring a normal state in an extremely short time even when there may be trouble.

### MEANS FOR SOLVING THE PROBLEMS

In order to achieve the foregoing object, the present invention provides a method for storing data in an electronic computer system including: a first storage device with fixed data stored therein; a second storage device divided into two or more regions and having variable data stored in one of the regions; and a third storage device adapted to constantly store the same data as that in the second storage device, the method including the step of storing the fixed data stored in the first storage device into another region of the second storage device at a predetermined timing.

Here, storing the fixed data stored in the first storage device, that is, data not to be changed after each use of the electronic computer system into another region of the second storage device, which is divided into two or more regions and having variable data, that is, data to be changed after each use of the electronic computer system stored in one of the regions, at a predetermined timing allows the fixed data stored in the first storage device to be backed up to another region of the second storage device. Additionally, since the backup is performed at a predetermined timing, that is, the backup is not performed in real time, fixed data in a state before various troubles occur can be stored as backup data.

Also, since the third storage device is adapted to constantly store the same data as that in the second storage device, it is possible to replicate backup data of the variable data stored in one region of the second storage device and the fixed data stored in another region of the second storage device. Additionally, since the third storage device replicates the second storage device constantly, that is, replicated data is stored in real time, replication of the latest user-created data can be stored.

Also, the present invention provides a method for storing data in an electronic computer system equipped with: a first storage device with first fixed data including user account information stored therein; a second storage device with second fixed data including account information common to the user account information stored in the first storage device stored therein; a third storage device divided into two or more regions and having first variable data stored in one of the regions; a fourth storage device divided into two or more regions and having second variable data stored in one of the regions; a fifth storage device adapted to constantly store the same data as that in the third storage device; and a sixth storage device adapted to constantly store the same data as that in the fourth storage device, the method composing the steps of: storing the first fixed data stored in the first storage device into another region of the third storage device at a first predetermined timing; and storing the second fixed data stored in the second storage device into another region of the fourth storage device at a second predetermined timing.

Here, storing the first fixed data stored in the first storage device into another region of the third storage device, which is divided into two or more regions and having first variable data stored in one of the regions, at a first predetermined timing allows the first fixed data stored in the first storage device to be backed up to another region of the third storage device. Furthermore, storing the second fixed data stored in the second storage device into another region of the fourth storage device, which is divided into two or more regions and having second variable data stored in one of the regions, at a second predetermined timing allows the second fixed data stored in the second storage device to be backed up to another region of the fourth storage device. Additionally, as with the case above, since the backup is not performed in real time, first and second fixed data in a state before various troubles occur can be stored as backup data.

Also, since the fifth storage device is adapted to constantly store the same data as that in the third storage device, it is possible to replicate backup data of the first variable data stored in one region of the third storage device and the first fixed data stored in another region of the third storage device. Furthermore, since the sixth storage device is adapted to constantly store the same data as that in the fourth storage device, it is possible to replicate backup data of the second variable data stored in one region of the fourth storage device and the second fixed data stored in another region of the fourth storage device. Additionally, as with the case above, since replicated data is stored in real time, replication of the latest user-created data can be stored.

Furthermore, since the second storage device stores account information common to the user account information stored in the first storage device, even if one of either the first or second storage device may crash, users can log into the electronic computer system.

In order to achieve the foregoing object, the present invention also provides an electronic computer system including: a first storage device with fixed data stored therein; a second storage device divided into two or more regions and having variable data stored in one of the regions; and a third storage device adapted to constantly store the same data as that in the second storage device, in which another region of the second storage device is adapted to store the fixed data stored in the first storage device at a predetermined timing.

The present invention further provides an electronic computer system including: a first storage device with fixed data stored therein; a second storage device divided into two or more regions and having variable data stored in one of the regions; and a third storage device adapted to constantly store the same data as that in the second storage device, the system further including storing means for storing the fixed data stored in the first storage device into another region of the second storage device at a predetermined timing.

Here, since another region of the second storage device is adapted to store the fixed data stored in the first storage device at a predetermined timing and there is provided storing means for storing the fixed data stored in the first storage device into another region of the second storage device at a predetermined timing, the fixed data stored in the first storage device can be backed up to another region of the second storage device.

Also, the present invention provides an electronic computer system equipped with: a first storage device with first fixed data including user account information stored therein; a second storage device with second fixed data including account information common to the user account information stored in the first storage device stored therein; a third storage device divided into two or more regions and having first variable data stored in one of the regions; a fourth storage device divided into two or more regions and having second variable data stored in one of the regions; a fifth storage device adapted to constantly store the same data as that in the third storage device; and a sixth storage device adapted to constantly store the same data as that in the fourth storage device, in which another region of the third storage device is adapted to store the first fixed data stored in the first storage device at a first predetermined timing, and another region of the fourth storage device is adapted to store the second fixed data stored in the second storage device at a second predetermined timing.

Also, the present invention provides an electronic computer system equipped with: a first storage device with first fixed data including user account information stored therein; a second storage device with second fixed data including account information common to the user account information stored in the first storage device stored therein; a third storage device divided into two or more regions and having first variable data stored in one of the regions; a fourth storage device divided into two or more regions and having second variable data stored in one of the regions; a fifth storage device adapted to constantly store the same data as that in the third storage device; and a sixth storage device adapted to constantly store the same data as that in the fourth storage device, the system further equipped with: first storing means for storing the first fixed data stored in the first storage device into another region of the third storage device at a first predetermined timing; and second storing means for storing the second fixed data stored in the second storage device into another region of the fourth storage device at a second predetermined timing.

Here, since another region of the third storage device is adapted to store the first fixed data stored in the first storage device at a first predetermined timing and there is provided first storing means for storing the first fixed data stored in the first storage device into another region of the third storage device at a first predetermined timing, the first fixed data can be backed up to another region of the third storage device. Furthermore, since another region of the fourth storage device is adapted to store the second fixed data stored in the second storage device at a second predetermined timing and there is provided second storing means for storing the second fixed data stored in the second storage device into another region of the fourth storage device at a second predetermined timing, the second fixed data can be backed up to another region of the fourth storage device.

### EFFECTS OF THE INVENTION

In the above-described method for storing data in an electronic computer system and electronic computer system according to the present invention, since the entire system environment (e.g. OS, installation information, account information, peripherals and networks information, application setting information) is backed up to another storage device at a constant timing, it is possible to restore the system environment in an extremely short time, even when there may be crashing and/or damage of a storage device.

Also, since there is no need for “reinstallation operation” that is performed commonly to restore systems, advanced system engineers are not required to be resident.

Furthermore, since data most important to users is stored in another storage device separately from the system and the replication thereof is generated automatically in still another storage device so that the data is duplicated, even if one storage device with the data stored therein may crash, the data stored in the other storage device can be utilized to achieve continuous system operation.

### BEST MODE FOR CARRYING OUT THE INVENTION

An embodiment of the present invention will hereinafter be described with reference to the accompanying drawings for understanding of the present invention.

FIG. 1 is a view typically illustrating an example of an electronic computer system to which the present invention is applied, where the single-server electronic computer system 1 is provided with three internal HDDs (HDD-A, HDD-B, and HDD-C) indicated by the reference numerals 2 to 4. The HDD-A is connected directly to a mother board 5, while the HDD-B and HDD-C are arranged in such a manner that the RAID-1 structure via a RAID board 6 performs mirroring.

The system region (A) of the HDD-A is installed with a server OS and application software, etc. Also, the HDD-B is partitioned into a data and cache region (B-1) and a system backup region (B-2), the data and cache region (B-1) being adapted to store data of the application software installed in the system region.

It is also arranged that changed portions of the server OS and application software, etc., installed in the system region be backed up to the system backup region (B-2) of the HDD-B by a general-purpose backup tool at a constant timing.

Although the present embodiment is here described citing a server provided with three internal HDDs as an example, the HDD-C only requires the capability of storing the same content as that in the HDD-B, and does not need to be incorporated in the server necessarily. That is, it may be arranged that the HDD-B and HDD-C be connected via a network and the same content as that in the HDD-B can be stored in the HDD-C via the network.

Although the present embodiment is also described citing an example in which the HDD-B and HDD-C are arranged in such a manner that the RAID-1 structure via the RAID board performs mirroring, the HDD-C only requires the capability of storing the same content as that in the HDD-B, and does not need to employ RAID-1 structure necessarily, and a general-purpose backup tool may be utilized for real-time backup.

In the example of the electronic computer system to which the present invention is applied, since the system region of the HDD-A is backed up at a scheduled constant timing, even if the system region of the HDD-A may crash, it is possible to restore the system region in a short time using normal system image files before the crash that are stored in the system backup region (B-2) of the HDD-B, and there is no need for reinstallation of the server OS and application software, network setting, or any other various settings.

Also, since data is stored in the data and cache region (B-1) of the HDD-B, while the server OS and application software, etc., are stored in the system region (A) of the HDD-A, that is, data to be stored in the server in a concentrated manner is separated from the server OS and application software, the data cannot be damaged due to crashing of the server OS and/or virus infection, etc.

Furthermore, since the HDD-C is generated by mirroring as a replicated HDD of the HDD-B for data storing, even if the HDD-B may be damaged physically, each piece of data does not come under the influence thereof.

FIG. 2 is a view typically illustrating another example of an electronic computer system to which the present invention is applied, where the two-server electronic computer system 7 consists of first and second servers 9 and 10 connected via a network 8.

The first server is provided with three internal HDDs (HDD-D, HDD-E, and HDD-F) indicated by the reference numerals 11 to 13, each HDD being connected directly to a motherboard. The second server is also provided with three internal HDDs (HDD-G, HDD-H, and HDD-I) indicated by the reference numerals 14 to 16, each HDD being connected directly to a motherboard.

The system region (D) of the HDD-D in the first server is installed with a server OS, the server OS being set as “Primary Domain Controller (PDC).”

The system region (G) of the HDD-G in the second server is also installed with a server OS, the server OS being set as “Backup Domain Controller (BDC).”

Here, PDC is for log in management as well as printer sharing management and serves as a file sharing server, while BDC is adapted to install server applications such as group ware and business-oriented databases. Additionally, account information for logging into the network is adapted to be copied automatically between PDC and BDC by the functions of the server OSs themselves.

Also, the HDD-E in the first server is partitioned into a data and cache region (E-1) and a system backup region (E-2), the data and cache region (E-1) being adapted to store data of the application software installed in the system region (D) of the HDD-D.

Similarly, the HDD-H in the second server is partitioned into a data and cache region (H-1) and a system backup region (H-2), the data and cache region (H-1) being adapted to store data of the application software installed in the system region (G) of the HDD-G.

It is also arranged that changed portions of the server OS and application software, etc., installed in the system region (D) of the HDD-D in the first server be backed up to the system backup region (E-2) of the HDD-E by a general-purpose backup tool at a constant timing.

Similarly, it is arranged that changed portions of the server OS and application software, etc., installed in the system region (G) of the HDD-G in the second server be backed up to the system backup region (H-2) of the HDD-H by a general-purpose backup tool at a constant timing.

It is further arranged that the entire HDD-E in the first server be copied automatically to the HDD-I in the second server through the network in real time. Similarly, it is arranged that the entire HDD-H in the second server be copied automatically to the HDD-F in the first server through the network in real time.

In a further example of the electronic computer system to which the present invention is applied, since account information for logging into the network is copied automatically and constantly between PDC and BDC, even if the PDC system may crash, client PCs can log into the network and utilize shared resources such as printers. Also, the PDC system itself can be restored in a short time using the latest system images stored in the HDD-E. Furthermore, during the restoration of the PDC system, clients can use data copied in BDC to advance their tasks.

Additionally, the same applies to the case where the BDC crashes.

Also, even if one piece of data and cache region of either PDC or BDC may crash, the system can be restored using copies stored in the non-crashing server.

Furthermore, since typical HDDs provided for client PC use may be used to establish an electronic computer system, it is possible to build a server at an extremely low cost. That is, no RAID board for replicating HDDs is required and thereby no extremely expensive RAID board is used, which makes it possible to build a server at a low cost.

### BRIEF DESCRIPTION OF THE DRAWINGS

FIG. 1 is a view typically illustrating an example of an electronic computer system to which the present invention is applied;

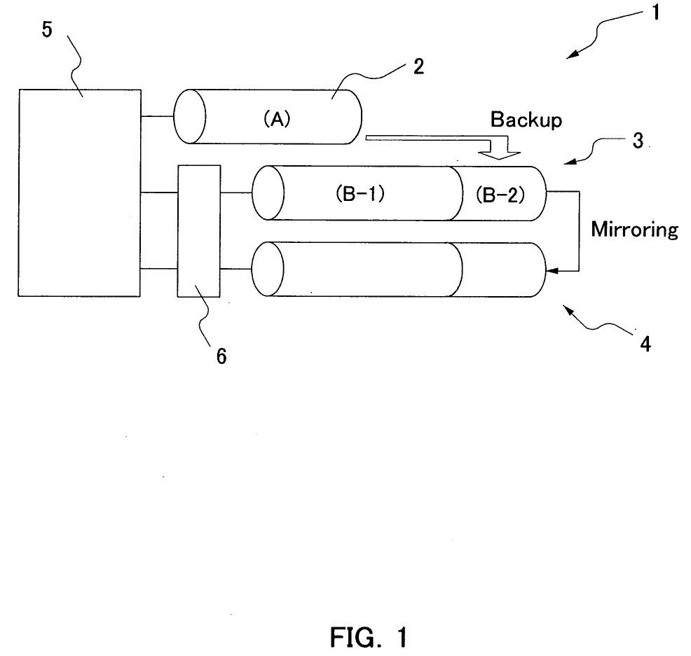

FIG. 2 is a view typically illustrating another example of an electronic computer system to which the present invention is applied; and

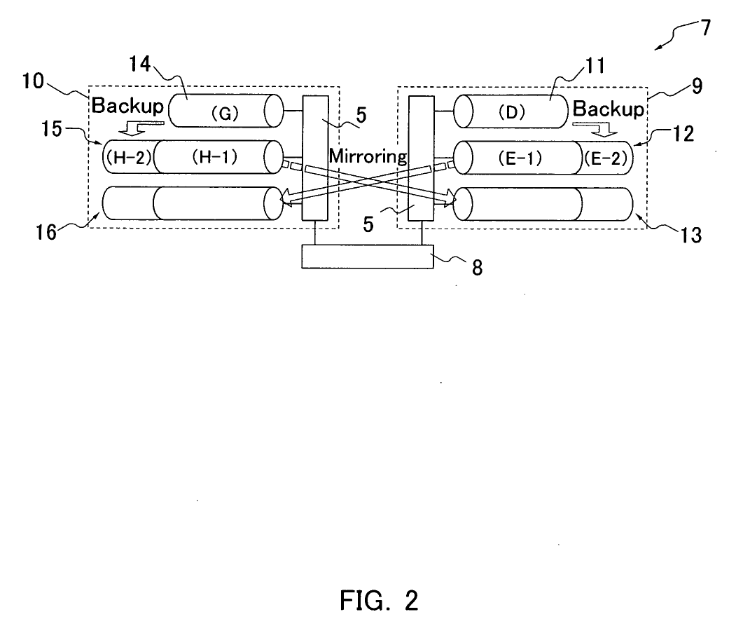

FIG. 3 is a view typically illustrating RAID structures.

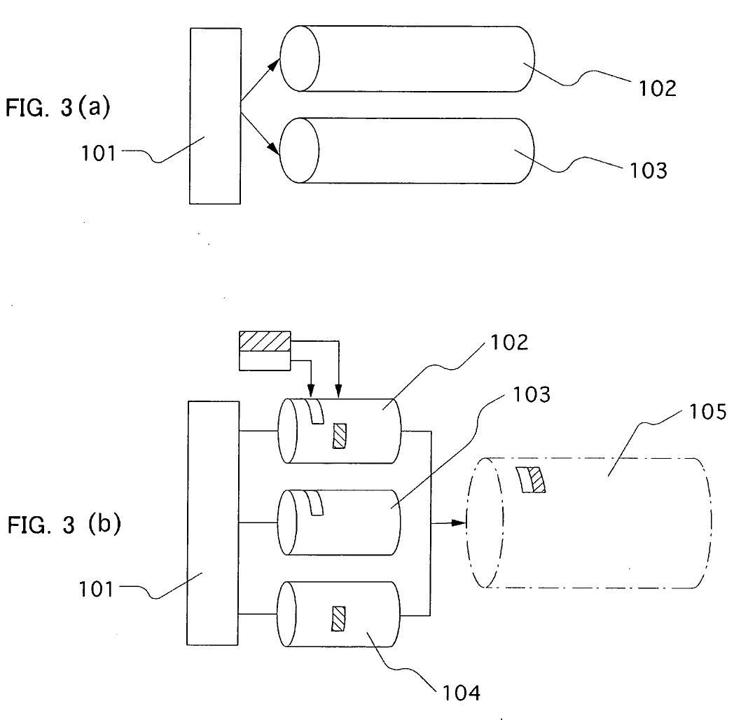

### DESCRIPTION OF SYMBOLS

1: Electronic computer system
2: HDD-A
3: HDD-B
4: HDD-C
5: Motherboard
6: RAID board
7: Electronic computer system
8: Network
9: First server
10: Second server
11: HDD-D
12: HDD-E
13: HDD-F
14: HDD-G
15: HDD-H
16: HDD-I

1. A method for storing data in an electronic computer system comprising:
a first storage device with fixed data stored therein;
a second storage device divided into two or more regions and having variable data stored in one of the regions; and
a third storage device adapted to constantly store the same data as that in the second storage device,
the method comprising the step of storing the fixed data stored in the first storage device into another region of the second storage device at a predetermined timing.

2. A method for storing data in an electronic computer system comprising:
a first storage device with first fixed data including user account information stored therein;
a second storage device with second fixed data including account information common to the user account information stored in the first storage device stored therein;
a third storage device divided into two or more regions and having first variable data stored in one of the regions;
a fourth storage device divided into two or more regions and having second variable data stored in one of the regions;
a fifth storage device adapted to constantly store the same data as that in the third storage device; and
a sixth storage device adapted to constantly store the same data as that in the fourth storage device,
the method comprising the steps of:
storing the first fixed data stored in the first storage device into another region of the third storage device at a first predetermined timing; and
storing the second fixed data stored in the second storage device into another region of the fourth storage device at a second predetermined timing.

3. An electronic computer system comprising:
a first storage device with fixed data stored therein;
a second storage device divided into two or more regions and having variable data stored in one of the regions; and
a third storage device adapted to constantly store the same data as that in the second storage device, wherein
another region of the second storage device is adapted to store the fixed data stored in the first storage device at a predetermined timing.

4. An electronic computer system comprising:
a first storage device with first fixed data including user account information stored therein;
a second storage device with second fixed data including account information common to the user account information stored in the first storage device stored therein;
a third storage device divided into two or more regions and having first variable data stored in one of the regions;
a fourth storage device divided into two or more regions and having second variable data stored in one of the regions;
a fifth storage device adapted to constantly store the same data as that in the third storage device; and
a sixth storage device adapted to constantly store the same data as that in the fourth storage device, wherein
another region of the third storage device is adapted to store the first fixed data stored in the first storage device at a first predetermined timing, and
another region of the fourth storage device is adapted to store the second fixed data stored in the second storage device at a second predetermined timing.

5. An electronic computer system comprising:
a first storage device with fixed data stored therein;
a second storage device divided into two or more regions and having variable data stored in one of the regions; and
a third storage device adapted to constantly store the same data as that in the second storage device,
the system further comprising storing means for storing the fixed data stored in the first storage device into another region of the second storage device at a predetermined timing.

6. An electronic computer system comprising:
a first storage device with first fixed data including user account information stored therein;
a second storage device with second fixed data including account information common to the user account information stored in the first storage device stored therein;
a third storage device divided into two or more regions and having first variable data stored in one of the regions;
a fourth storage device divided into two or more regions and having second variable data stored in one of the regions;
a fifth storage device adapted to constantly store the same data as that in the third storage device; and
a sixth storage device adapted to constantly store the same data as that in the fourth storage device,
the system further comprising:
first storing means for storing the first fixed data stored in the first storage device into another region of the third storage device at a first predetermined timing; and
second storing means for storing the second fixed data stored in the second storage device into another region of the fourth storage device at a second predetermined timing.
